(19) United States
(12) Patent Application Publication
(10) Pub. No.: US 2023/0087050 A1
(43) Pub. Date: Mar. 23, 2023

(54) Bearing for a sand/salt spreader

(71) Applicant: Brian Capone Land Services, LLC, Stamford, CT (US)

(72) Inventor: Brian Capone, Stamford, CT (US)

(21) Appl. No.: 17/932,859

(22) Filed: Sep. 16, 2022

Related U.S. Application Data
(60) Provisional application No. 63/245,376, filed on Sep. 17, 2021.

(51) Int. Cl. E01H 10/00; F16C 19/06

(52) U.S. Cl. CPC E01H 10/007; F16C 19/06

(57) ABSTRACT

A pillow block assembly for a sand and/or salt spreader includes a housing having a central body and two mounting flanges disposed on opposing sides of the central body, the mounting flanges extending outwardly from the central body, the housing being composed of PBT or a PBT-based composite, the housing having a bore which extends through the central body in a transverse direction; and a bearing positioned within the bore, the bearing includes at least one ball bearing or at least one roller bearing, the bearing being composed of stainless steel and configured to receive a spinner shaft of the sand and/or salt spreader. The PBT or PBT-based composite housing is mountable within an interior of a chute of the sand and/or salt spreader via the mounting flanges.

### TECHNICAL FIELD

The present teachings relate generally to bearings. More specifically, the present teachings relate to a pillow block bearing, a spinner shaft assembly having the pillow block bearing, and a sand and/or salt spreader having the spinner shaft assembly.

### BACKGROUND

In the de-icing industry, a vehicle-mountable sander and/or salt spreader is a widely used piece of machinery. This equipment utilizes energy produced by a gas or electric motor and transfers power to a gearbox. The gearbox then converts that energy to a series of shafts. These shafts are responsible for calibrated movement of both a conveyor and a spinner shaft in unison. The conveyor moves the product material (e.g., sand, salt pellets, etc.) to a back chute which is calibrated by the user to deploy a desired quantity of road salt or sand. From the chute, the salt or sand drops onto a spinner shaft. This spinner shaft is a long steel shaft, typically ¾″ or 1″ diameter, with a spinner, auger, impeller, or spreading disc (herein referred to individually and/or collectively as a “spinner”) attached at the bottom of the shaft. The spinner spins in a clockwise or counterclockwise motion. This spinner comprises a circular or substantially circular-shaped plate and has a series of raised ridges or vanes, for example 3 or 4 ridges, that catch the material and create a centrifugal force as the spinner rotates. This rotation ejects and distributes the material outward onto the ground from the vehicle as the vehicle moves. This process is what we see when driving behind a highway or roadway salt spreader.

The ¾ in. or 1 in. spinner is fastened to the chute by two, three, or sometimes four pillow block bearings. The pillow block bearings are mounted inside the chute so that the spinner is centered within the chute. This configuration exposes the pillow block bearings to all materials that pass through the chute. Accordingly, the longevity of a pillow block bearing is thus highly dependent on the care or neglect of the user.

Conventional pillow block bearings experience excessive wear and tear due to their exposure with the materials that pass through the chute, and thus consistently fail. For example, the steel housing of the pillow block bearing is prone to corrosion and often fails as a result of rusting. The conventional pillow block bearings, especially their housings, also undergo swelling/expansion and contraction brought about by the combined effects of rock salt, melting ice, and/or extreme temperature variations (i.e., freeze-thaw cycles). The rusting and swelling leads to abrasion of the roller/ball bearing within the housing. This wear causes a spinner to spin out of alignment creating heat, friction, and further instability. If the user does not grease the steel roller/ball bearing frequently, the swelling will get worse, and can lead to complete seizure or the bearing disengaging from the housing, thereby rendering the pillow block destroyed. The inability to properly clean de-icing equipment in winter months (due to outside storage, frequent repeated use without cleaning, and freezing temperatures) are various reasons why conventional steel pillow block bearings fail.

Conventional pillow block bearings used for the spinner shaft assembly in the de-icing industry are made of steel and have a grease zerk. The grease zerk has a grease fitting on the round side of the pillow block housing. However, since the pillow block bearing is installed within the chute, a user must reach up inside the chute in order to connect a grease gun to the zerk. This can be a difficult task, especially since the chute may be up to 36″ or more in length. Moreover, there is a safety issue as the user's hand and/or arm may potentially be injured through contact with other components within the chute and/or inadvertent powering of the sand and/or salt spreader.

In addition, conventional pillow block bearings are not able to adequately handle axial loads that may be directed through the spinner shaft and transmitted to the bearings. This can lead to a reduction in the useable life of the bearing and failure of the bearing.

Thus, there exists a need for a new and improved design of the pillow block bearing, as well as a corresponding spinner shaft assembly and a corresponding sand and/or salt spreader, that overcomes the above problems in conventional pillow block bearings.

### SUMMARY

The needs set forth herein as well as further and other needs and advantages are addressed by the present embodiments, which illustrate solutions and advantages described below.

It is an object of the present teachings to remedy the above drawbacks and shortcomings associated with conventional pillow block bearings.

In particular, it is an object of the present teachings to provide a pillow block that has a higher tolerance against wear and tear, especially when utilized in snow or de-icing applications.

It is another object of the present teachings to provide a pillow block that exhibits a longer useful life compared to conventional pillow block bearings.

It is also another object of the present teachings to provide a pillow block that withstands axial loads that may be transmitted from the spinner.

These and other objects of the present teachings are achieved by providing a pillow block assembly for a sand and/or salt spreader. The pillow block assembly comprises a housing having a central body and two mounting flanges disposed on opposing sides of the central body. The mounting flanges extend outwardly from the central body. The housing is composed of PBT or a PBT-based composite and has a bore which extends through the central body in a transverse direction. The pillow block assembly further comprises a bearing positioned within the bore. The bearing includes at least one ball bearing or at least one roller bearing, wherein the bearing is composed of stainless steel and configured to receive a spinner shaft of the sand and/or salt spreader. The PBT or PBT-based composite housing is mountable within an interior of a chute of the sand and/or salt spreader via the mounting flanges.

The present teachings also provide a spinner shaft assembly for a sand and/or salt spreader. The spinner shaft assembly comprises a rotatable shaft and a spinner attached to one end of the shaft. The spinner includes a substantially circular plate and a plurality of vanes on the plate. The spinner shaft assembly further comprises at least one pillow block assembly, which includes a housing having a central body and two mounting flanges disposed on opposing sides of the central body, the mounting flanges extending outwardly from the central body, the housing being composed of PBT or a PBT-based composite, the housing having a bore which extends through the central body in a transverse direction; and a bearing positioned within the bore, the bearing includes at least one ball bearing or at least one roller bearing, the bearing being composed of stainless steel and receiving the shaft. The PBT or PBT-based composite housing is mounted within an interior of a chute of the sand and/or salt spreader via the mounting flanges.

The present teachings also provide a sand and/or salt spreader, which comprises a gearbox connected to a pulley via a belt, the gearbox being configured to transfer power from a motor to the pulley; a chute providing a channel for conveying one or more materials; and a spinner shaft assembly installed within the chute. The spinner shaft assembly includes: a rotatable shaft having a proximal section where the pulley is attached; a spinner attached to a distal end of the shaft, the spinner comprising a substantially circular plate and a plurality of vanes on the plate; and at least one pillow block assembly. The pillow block assembly includes: a housing having a central body and two mounting flanges disposed on opposing sides of the central body, the mounting flanges extending outwardly from the central body, the housing being composed of PBT or a PBT-based composite, the housing having a bore which extends through the central body in a transverse direction; and a bearing positioned within the bore, the bearing includes at least one ball bearing or at least one roller bearing, the bearing being composed of stainless steel and receiving the shaft. The PBT or PBT-based composite housing is mounted within an interior of the chute via the mounting flanges.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 is an image of a pillow block bearing assembly according to the present teachings, showing a front perspective view thereof.

FIG. 2 is an image of the pillow block bearing assembly of FIG. 1, showing a rear perspective view thereof.

FIG. 3 is a schematic of the pillow block bearing assembly of FIG. 1, showing a front view thereof.

FIG. 4 is a schematic of the pillow block bearing assembly of FIG. 1, showing a side view with a partial cross-section.

FIG. 5 is an exploded view of an exemplary vehicle-mountable sand and/or salt spreader comprising the pillow block bearing assembly of FIG. 1.

A component or a feature that is common to more than one drawing is indicated with the same reference number in each of the drawings.

### DETAILED DESCRIPTION

The present teachings are described more fully hereinafter with reference to the accompanying drawings, in which the present embodiments are shown. The following description is presented for illustrative purposes only, and the present teachings should not be limited to these embodiments.

The present teachings have been described in language more or less specific as to structural and mechanical features. It is to be understood, however, that the present teachings are not limited to the specific features shown and described, since the device, apparatus, and/or system herein disclosed comprises preferred forms of putting the present teachings into effect.

For purposes of explanation and not limitation, specific details are set forth such as particular structures, architectures, interfaces, techniques, etc. in order to provide a thorough understanding. In other instances, detailed descriptions of well-known devices and/or methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The use of “first”, “second,” etc. for different features/components of the present disclosure are only intended to distinguish the features/components from other similar features/components and not to impart any order or hierarchy to the features/components.

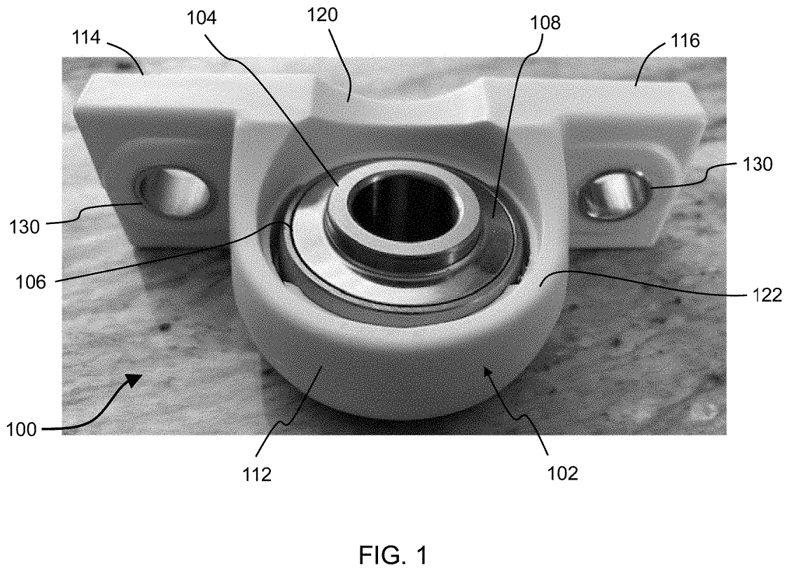

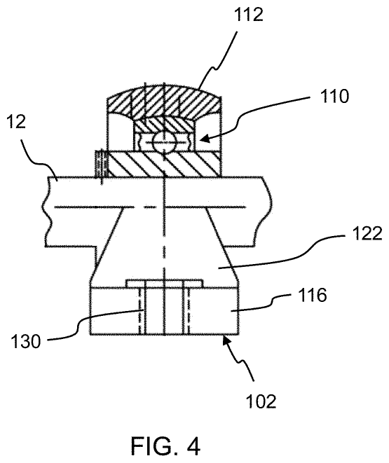

Referring to FIGS. 1-4, a pillow block bearing assembly of device 100 according to the present teachings is shown. The pillow block bearing assembly 100 includes a pillow block housing 102, and a bearing 104 carried within the pillow block housing 102. In particular, the bearing 104 is positioned in a bore 106 which extends through the housing body in a transverse direction. The bearing 104 may comprise one or more balls bearings or one or more roller bearings to enable rotation of the bearing 104 while arranged in the housing 102. The bearing 104 may be composed of stainless steel, such as 420 stainless steel. The bearing 104 is configured to receive, for example but not limited to, a ¾ in. or 1 in. diameter shaft. The pillow block bearing assembly 100 also has two seals 108, 109 mounted on opposing sides of the housing 102 within the bore 106.

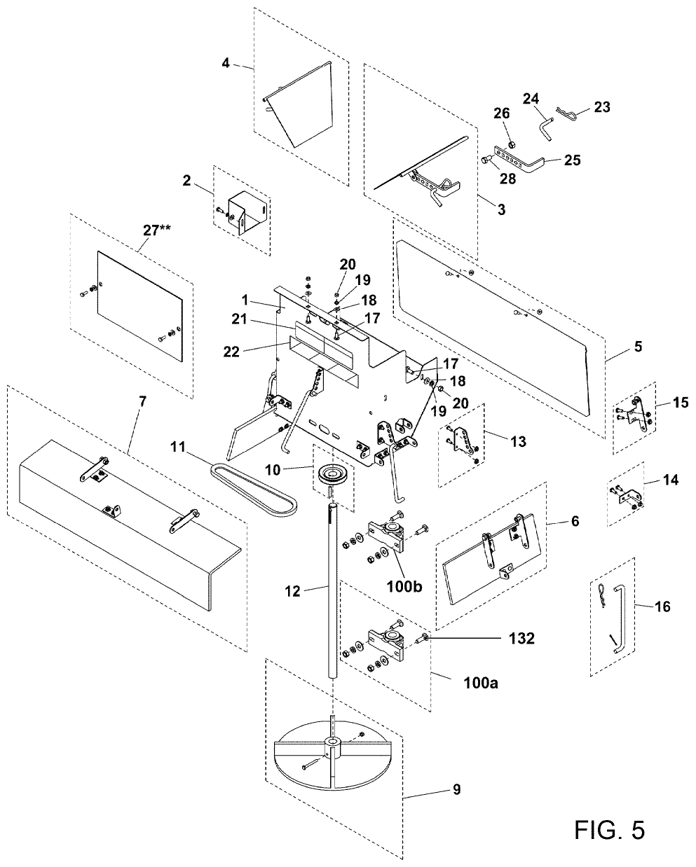

The pillow block housing 102 has a central body 112 and two mounting flanges—first mounting flange 114 and second mounting flange 116—for securing the pillow block bearing assembly to a structural object, such as a chute of a spreader or broadcast spreading machine (e.g., vehicle-mountable sand or salt spreader). The flanges 114, 116 extend outwardly from the central body 112, thereby defining a longitudinal extent of the pillow block bearing assembly 100. As shown clearly in FIG. 1, each flange comprises an insert aperture 130 adapted to receive a mechanical fastener 132 (FIG. 5), such as a screw, nail, bolt, peg, or other similar fastening hardware.

The central body 112 comprises a base portion 120 at a proximal end and a cavity section 122 extending in a distal direction away from the base portion 120. The base portion is defined by a planar or substantially planar surface 124, which in combination with the mounting flanges forms the bottom surface of the pillow block bearing assembly 100. The cavity section 122 of the central body 112 has a U-shaped or substantially U-shaped border with a curved or rounded exterior surface and an interior surface defining the bore 106.

The pillow block housing 102 is composed of polybutylene terephthalate, also known as “PBT”, or a PBT-based composite. This is in contrast to conventional pillow block bearings, which comprise a steel housing. PBT has and exhibits several advantageous qualities, including high abrasion resistance, low temperature performance, high shear strength, and oil and grease resistance. These qualities provide significant benefits in the snow and de-icing industry. For example, salt and sand are highly abrasive. Temperature and moisture variations are a major influence on the performance of the pillow block bearing. The PBT or PBT-based composite provides superior characteristics relative to stainless steel, including being more resistant to the negative impacts of salt and sand as well as extreme temperature and moisture variations. Also, the high shear strength of PBT or the PBT-based composite ensures that the revolutions of the spinner under tension will not deform the bearing 104 or cause failure of the bearing seat 110.

The pillow block bearing assembly 100 with its housing 102 made of PBT or a PBT-based composite provides benefits not only in the snow and de-icing industry, but in other applications as well, such as but not limited to the food industry and food processing industry. Conventional bearings used in baking and food preparation are often exposed to frequent and daily washing. Food preparation also contains high amounts of corrosives and salts, thereby causing conventional steel-housing based bearings to corrode and/or rust. Conventional bearings are also utilized in everything from conveyor style refrigeration to freezer applications. The conventional bearings are sensitive to the extreme temperatures and/or temperature variations caused by the refrigeration/freezer and thus are prone to swelling, which leads to abrasion of the bearings within their housings. In contrast, the pillow block bearing assembly 100 according to the present teachings is able to overcome the drawbacks of conventional bearings by way of the PBT composition of the pillow block housing 102.

The PBT or PBT-based composite of the pillow block housing has been tested to withstand the elements of frequent washing, cold, heat (e.g., up to 140° F.), abrasion, and oil resistance, which are necessities in designing a ruggedized pillow block bearing assembly for snow or de-icing industry. Note, PBT inherently has limited UV resistances and stability. However, the pillow block bearing assembly 100 according to the present teachings does not require any UV protection since the housing and bearing unit are installed within the chute (of a sand and/or salt spreader) and thus are not exposed to UV light. Accordingly, PBT provides exceptional benefits for use in snow and de-icing applications.

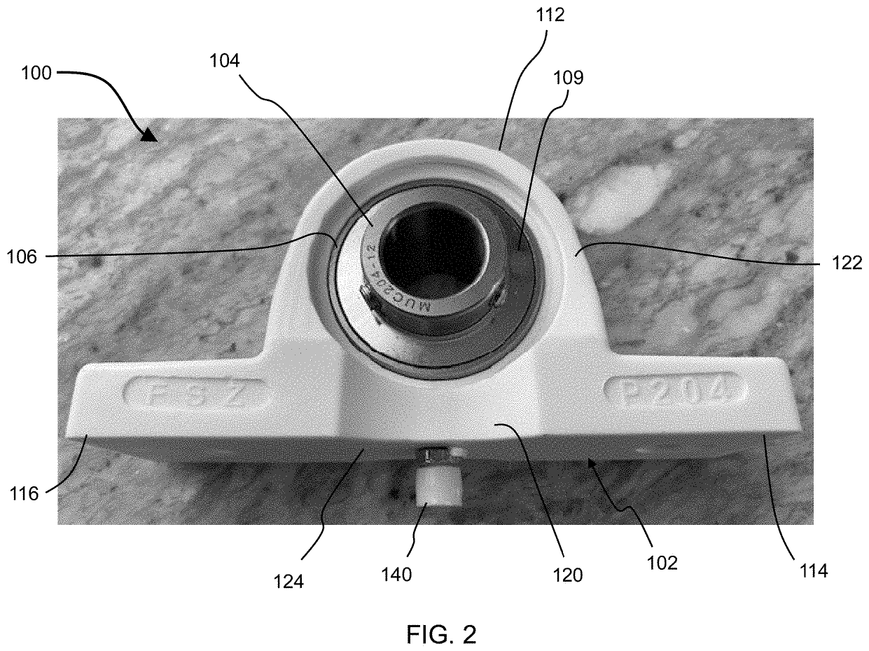

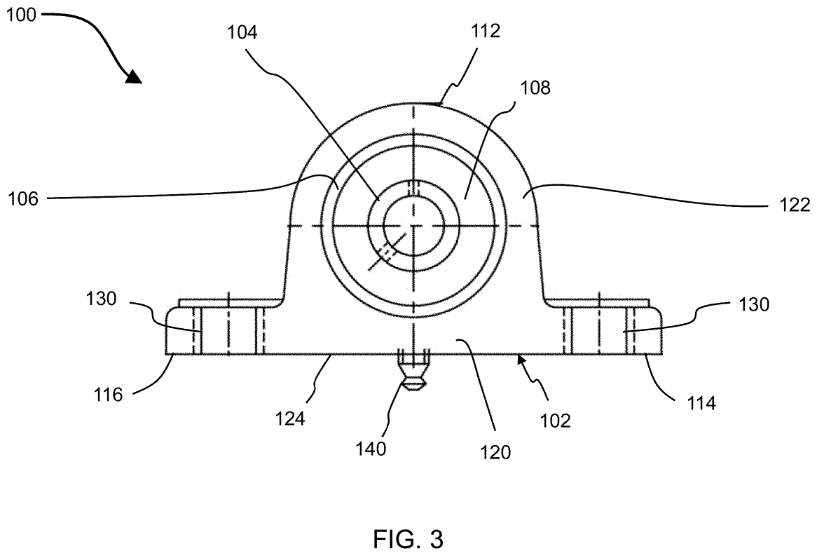

Referring to FIGS. 2-3, the pillow block housing 102 has a grease zerk 140. The grease zerk 140 is positioned on the planar surface 124 of the base portion 120 of the central body 112. As such, the grease zerk 140 can be indicated as a “bottom” grease zerk. This is in contrast to conventional pillow block bearings, which have a grease zerk on the round side of the central body (i.e., cavity section) of the pillow block housing. The unique configuration and location of the grease zerk 140 according to the present teachings provide for the pillow block bearing assembly to be mounted flat against a surface (e.g., interior surface of chute), while still allowing a user to grease the pillow block bearing from outside of the chute, without having to reach up inside the chute which can be up to 36 inches or more. It is also readily apparent that the bottom grease zerk configuration promotes user safety as the user need not extend his or her arm into the chute in order to grease the pillow block bearing. While greasing is essential for any bearing, the combination of PBT pillow block housing and stainless steel bearing helps to reduce bearing fatigue by working in unison to repel water, abrasion, and resist corrosion from current treated and untreated de-icing mixes.

FIG. 5 illustrates an exploded view of an exemplary vehicle-mountable sand and/or salt spreader according to the present teachings. The spreader includes a chute housing 1 with a shaft 12 positioned within the chute housing 1. The shaft 12 may have a diameter of, for example but not limited to, ¾ in. or 1 in. The length of the shaft 12 may be, for example but not limited to, 14 in., 26 in., 36 in. or longer. A spinner 9 (spinner, auger, impeller, or spreading disc) is fixedly attached to the bottom or distal end of the shaft 12. In some embodiments, the spinner 9 is arranged partially outside the chute housing 1. In other embodiments, the spinner 9 is arranged to be completely outside the chute housing 1. For rotating the shaft 12, the spreader includes a pulley 10 and a belt 11, wherein the pulley 10 is fastened at or proximate to the top or proximal end of the shaft 12 and engaged with the belt 11 in order to convert a driving force from a motor (e.g., gas motor, electric motor) and/or gearbox into rotational force. The spreader also includes at least one PBT or PBT-based composite pillow block bearing assembly 100, as described above, for receiving and supporting the shaft 12. Preferably, as shown in FIG. 5, there are at least two pillow block bearing assemblies 100a, 100b that support the shaft 12. Although not shown, the spreader may have three, four, or five pillow block bearing assemblies. The pillow block bearing assemblies 100a, 100b are mounted to an interior surface of the chute housing 1 via the flanges 114, 116 and mechanical fasteners 132. In particular, the base portion 120 of the central body 112 is configured to contact the interior surface of the chute housing 1 once mounting of the pillow block bearing assembly is completed. Furthermore, the wall of the chute housing 1 which corresponds with placement of the pillow block bearing assembly may have an opening or hole through which the grease zerk 140 extends, such that the grease zerk is accessible from outside the chute. The dimensions of the opening (e.g., diameter) is substantially equal to or slightly larger than an interior diameter of the opening. The grease zerk therefore is fitted within the opening, and no material passing through the chute is able to exit out of the chute through any space, if present, between the grease zerk and the opening. This allows a user to safely grease the pillow block bearing from outside of the chute. The spreader may also include one or more of the following components:
2 output guard
3 internal baffle passenger side
4 internal baffle driver side
5 front deflector
6 side deflector
7 rear deflector
13 adjustment bracket
14 baffle tab
15 hinge kit, rear and side baffles
16 baffle adjustment rod
17 carriage bolt
18 plain washer
19 lock washer
20 hex nut
21 information label
22 reflective strip
23 hairpin cotter
24 adjustment pin
25 baffle handle
26 hex jam locknut
27 access panel
28 hex cap screw

A detailed description of these components is not provided here since it is not necessary for understanding the present invention and since these components are known to those skilled in the art.

While the present teachings have been described above in terms of specific embodiments, it is to be understood that they are not limited to those disclosed embodiments. In fact, it will be apparent to those skilled in the art that various modifications and variations can be made in the present invention without departing from the scope or spirit of the invention, and such modifications and variations are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

What is claimed is:

1. A pillow block assembly for a sand and/or salt spreader comprising:
a housing having a central body and two mounting flanges disposed on opposing sides of the central body, the mounting flanges extending outwardly from the central body, the housing being composed of PBT or a PBT-based composite, the housing having a bore which extends through the central body in a transverse direction; and
a bearing positioned within the bore, the bearing includes at least one ball bearing or at least one roller bearing, the bearing being composed of stainless steel and configured to receive a spinner shaft of the sand and/or salt spreader;
wherein the PBT or PBT-based composite housing is mountable within an interior of a chute of the sand and/or salt spreader via the mounting flanges.

2. The pillow block assembly of claim 1, wherein the central body has a base portion and a cavity portion extending in a distal direction away from the base portion, wherein the cavity portion includes the bore in which the bearing is disposed, and wherein the base portion includes a planar surface, which in combination with the mounting flanges, forms a bottom surface of the pillow block assembly.

3. The pillow block assembly of claim 2, further comprising a grease zerk disposed at the planar surface of the central body, the grease zerk having a dimension that fits through an opening in the chute of the sand and/or salt spreader.

4. The pillow block assembly of claim 3, wherein the grease zerk extends in a proximal direction away from the planar surface of the central body.

5. The pillow block assembly of claim 3, wherein the grease zerk extends perpendicularly relative to the planar surface of the central body.

6. A spinner shaft assembly for a sand and/or salt spreader comprising:
a rotatable shaft;
a spinner attached to one end of the shaft, the spinner comprising a substantially circular plate and a plurality of vanes on the plate; and
at least one pillow block assembly, which includes:
a housing having a central body and two mounting flanges disposed on opposing sides of the central body, the mounting flanges extending outwardly from the central body, the housing being composed of PBT or a PBT-based composite, the housing having a bore which extends through the central body in a transverse direction; and
a bearing positioned within the bore, the bearing includes at least one ball bearing or at least one roller bearing, the bearing being composed of stainless steel and receiving the shaft;
wherein the PBT or PBT-based composite housing is mounted within an interior of a chute of the sand and/or salt spreader via the mounting flanges.

7. The spinner shaft assembly of claim 6, wherein the central body has a base portion and a cavity portion extending in a distal direction away from the base portion, wherein the cavity portion includes the bore in which the bearing is disposed, and wherein the base portion includes a planar surface, which in combination with the mounting flanges, forms a bottom surface of the pillow block assembly.

8. The spinner shaft assembly of claim 7, wherein the pillow block assembly includes a grease zerk disposed at the planar surface of the central body, the grease zerk having a dimension that fits through an opening in the chute of the sand and/or salt spreader.

9. The spinner shaft assembly of claim 8, wherein the grease zerk extends in a proximal direction away from the planar surface of the central body.

10. The spinner shaft assembly of claim 8, wherein the grease zerk extends perpendicularly relative to the planar surface of the central body.

11. A sand and/or salt spreader, comprising:
a gearbox connected to a pulley via a belt, the gearbox being configured to transfer power from a motor to the pulley;
a chute providing a channel for conveying one or more materials;
a spinner shaft assembly installed within the chute, the spinner shaft assembly includes:
a rotatable shaft having a proximal section where the pulley is attached;
a spinner attached to a distal end of the shaft, the spinner comprising a substantially circular plate and a plurality of vanes on the plate; and
at least one pillow block assembly, which includes:
a housing having a central body and two mounting flanges disposed on opposing sides of the central body, the mounting flanges extending outwardly from the central body, the housing being composed of PBT or a PBT-based composite, the housing having a bore which extends through the central body in a transverse direction; and
a bearing positioned within the bore, the bearing includes at least one ball bearing or at least one roller bearing, the bearing being composed of stainless steel and receiving the shaft;
wherein the PBT or PBT-based composite housing is mounted within an interior of the chute via the mounting flanges.

12. The sand and/or salt spreader of claim 11, wherein the central body has a base portion and a cavity portion extending in a distal direction away from the base portion, wherein the cavity portion includes the bore in which the bearing is disposed, and wherein the base portion includes a planar surface, which in combination with the mounting flanges, forms a bottom surface of the pillow block assembly.

13. The sand and/or salt spreader of claim 12, wherein the pillow block assembly includes a grease zerk disposed at the planar surface of the central body, and
wherein one wall of the chute has an opening through which the grease zerk extends out of the chute, the grease zerk having a dimension that corresponds with a dimension of the opening such that said one or more materials is prevented from passing between the opening and the grease zerk.

14. The sand and/or salt spreader of claim 13, wherein the grease zerk extends in a direction away from the planar surface of the central body.

15. The sand and/or salt spreader of claim 13, wherein the grease zerk extends perpendicularly relative to the planar surface of the central body.

16. The sand and/or salt spreader of claim 11, wherein the spinner shaft assembly includes two or more pillow block assemblies that are arranged in parallel with one another.

17. The sand and/or salt spreader of claim 11, wherein the chute is fastened to a vehicle.
